(19) United States
(12) Patent Application Publication
(10) Pub. No.: US 2010/0117949 A1
(43) Pub. Date: May 13, 2010

(54) CONTROL METHOD FOR BACKLIGHT MODULE OF LCD AND APPLICATION THEREOF

(75) Inventors: Pei-Ling LAI, TAIPEI HSIEN (TW); Chia-Hsien LI, TAIPEI HSIEN (TW)

Correspondence Address: BRIAN M. MCINNIS, 12th Floor, Ruttonjee House, 11 Duddell Street, Hong Kong, HK

(73) Assignee: WISTRON CORP., TAIPEI HSIEN (TW)

(21) Appl. No.: 12/482,467

(22) Filed: Jun. 11, 2009

(30) Foreign Application Priority Data
Nov. 10, 2008 (TW) 97143421

(51) Int. Cl. G09G 3/36; G06K 9/00; H04N 7/18

(52) U.S. Cl. 345/102; 382/118; 348/143

(57) ABSTRACT

A control method for a backlight module of a liquid crystal display (LCD) is disclosed. The control method for the backlight module of the LCD includes following steps: capturing an image in front of the LCD by a camera periodically; recording time at which the image is captured when there is no human face detected in the image; calculating elapsed time, which there has been no human face detected in the image for, according to the recorded times; turning off the backlight module of the LCD when the elapsed time is longer than turn-off time for backlight.

### RELATED APPLICATIONS

This application claims priority to Taiwan Application Serial Number 97143421, filed Nov. 10, 2008, which is herein incorporated by reference.

### BACKGROUND

1. Field of Invention

The present invention relates to a control method for a backlight module of a liquid crystal display (LCD) of an electrical device. More particularly, the present invention relates to a power saving method through controlling the backlight module of the LCD of the electrical device.

2. Description of Related Art

Nowadays, several low power chips and low power techniques for laptop computers have been developed to extend battery life of laptop computers by reducing power consumption. Power consumption of a LCD of a laptop computer is about 20%˜40% of the total power consumption of the laptop computer. Therefore, reducing the power consumption of the LCD can extend the battery life of the laptop computer significantly.

In the prior art, when the laptop computer is not operating for a period of time, which may imply that the user leaves the laptop computer and doesn't need the LCD to display, the laptop computer shuts down the LCD of the laptop computer. Therefore, the power consumption of the laptop computer is saved through shutting down the LCD. However, when the user utilizes the laptop computer to watch a movie, the user won't use any other operations on the laptop computer. Thus, when the user utilizes the laptop computer to watch a movie without using any other operations on the laptop computer for a period of time, the LCD of the laptop computer may be shut down, which may disturb the user.

Above all, a control method for the LCD is needed to prevent shutting down the LCD when the user is still utilizing the LCD without any other operation for a period of time, such as utilizing the LCD to watch movie.

### SUMMARY

According to one embodiment of this invention, a control method for a backlight module of a LCD includes following steps: Capture an image in front of the LCD by a camera periodically. When there is no human face detected in the image, record the time at which the image is captured. Next, calculate the elapsed time, which there has been no human face detected in the image for, according to the recorded times. When the elapsed time is longer than the turn-off time for backlight, turn off the backlight module of the LCD.

According to another embodiment of this invention, an electrical device includes a camera, a LCD, a display control unit, a detect instruction database and a processing unit. The camera captures an image of the objects in front of the LCD periodically. The LCD includes a backlight module. The display control unit controls the LCD. The detect instruction database stores at least one detect instruction. The processing unit includes a detecting module, a time module and a turning-off module. The detecting module detects if there is a human face in the image with the detect instruction. When there is no human face detected in the image, the time module records the time at which the camera captures the image and calculates the elapsed time, which there has been no human face detected in the image for, according to the recorded times. When the elapsed time is longer than the preset turn-off time for backlight, the turning-off module turns off the backlight module of the LCD through the display control unit.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow diagram of a control method for a backlight module of a LCD according to an embodiment of this invention;

FIG. 2 is an embodiment of step 180 and step 190 in FIG. 1; and

FIG. 3 is a block diagram of an electrical device according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

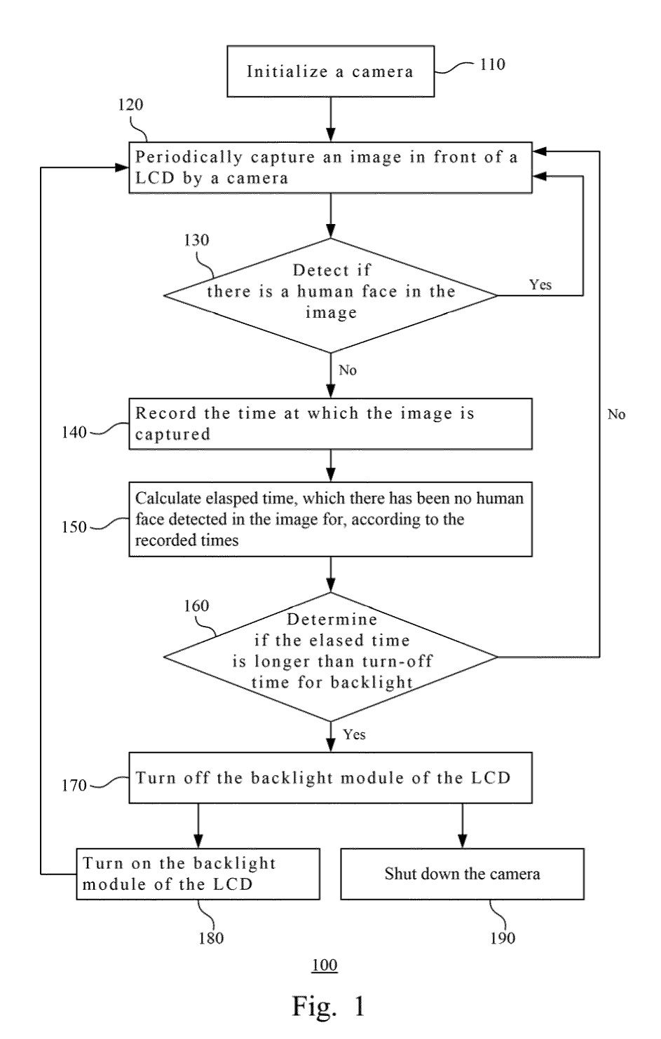

FIG. 1 is a flow diagram of a control method for a backlight module of a liquid crystal display (LCD) according to an embodiment of this invention. The control method detects if there is any user in front of the LCD. When no user face is detected for a period of time, the backlight module of the LCD is turned off. The control method for the backlight module of the LCD 100 includes following steps:

Initialize a camera (step 110) and periodically capture an image in front of a LCD by a camera (step 120). In step 130, detect if there is a human face in the image to determine if there is any user in front of the LCD. The detection in step 130 may be accomplished through utilizing face detection software to determine if there is any human facial features, such as eyebrows, nose, mouth or any other human facial features, in the image.

If a human face is detected in the image, the system assumes that there is a user in front of the LCD, and that the user may be utilizing the LCD. Therefore, when a human face is detected in the image, an image in front of the LCD is captured periodically (step 120) to detect if a human face is in the images (step 130) without turning off the backlight module of the LCD. Thus, when the user is still utilizing the LCD without any other operations, such as utilizing the LCD to watch a movie, the backlight module of the LCD would not be shut down.

If no human face is detected in the image, there may be no user in front of the LCD, which implies that there is no user utilizing the LCD. When there has been no user in front of the LCD for a period of time, the user may have left the front of the LCD for a long time, which implies that the backlight module of the LCD can be turned off to save power consumption without disturbing the user. Therefore, in step 140, record the time at which the image is captured when no human face is detected in the image. In step 150, calculate the elapsed time, which there has been no human face detected in the image for, according to the recorded times. In other words, there has been no user's face feature in front of the LCD for the elapsed time. The elapsed time can be calculated according to continuous count number of the recorded times or continuous accumulated value of the recorded times. In step 160, determine if the elapsed time is longer than turn-off time for backlight. The turn-off time for backlight can be set through a user interface. When the elapsed time is shorter than the turn-off time for backlight, keep capturing an image periodically (step 120). Otherwise, turn off the backlight module of the LCD when the elapsed time is longer than the turn-off time for backlight (step 170). In other words, the backlight module of the LCD is turned off when no human face feature is detected in the image for a period longer than the turn-off time for backlight.

Since the backlight module consumes more power than other elements of the LCD, turning off the backlight module can significantly reduce the power consumption of the LCD. In addition, power consumed by a normal camera, such as a WEBCAM, is much less than power saved by turning off the backlight module. Therefore, applying the control method for the backlight module of the LCD 100 can still reduce power consumption of the LCD significantly with the camera periodically capturing an image in front of the LCD. Thus, when using a battery to supply power to the LCD, the battery life can be extended by applying the control method for the backlight module of the LCD 100.

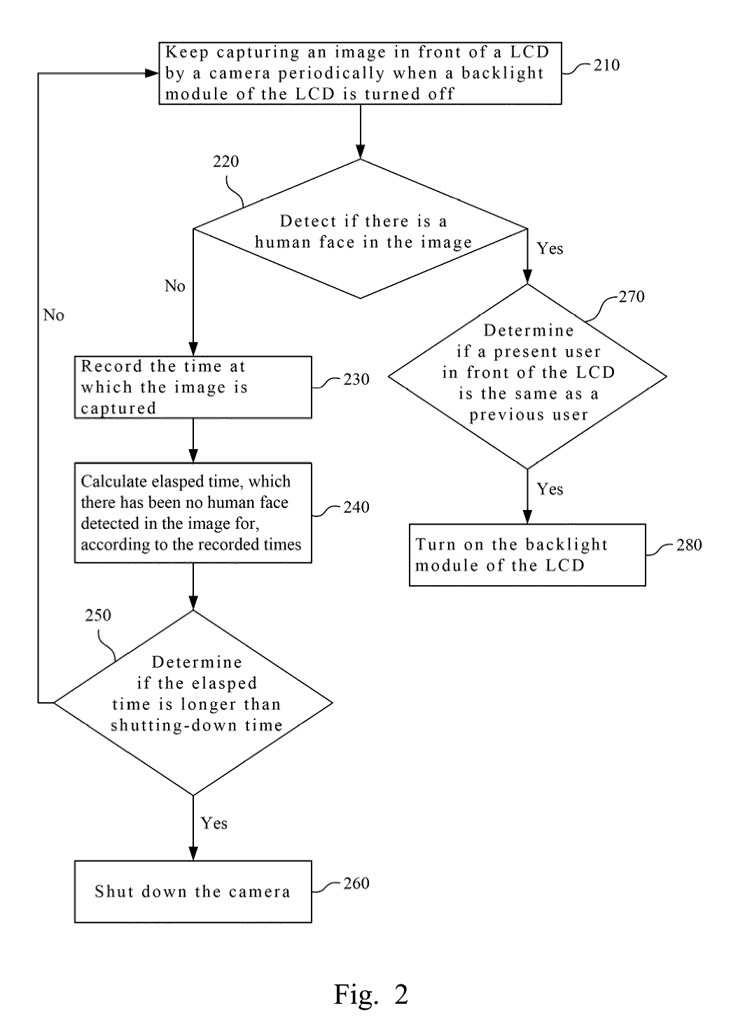

The control method for the backlight module of the LCD 100 may include the step of turning on the backlight module of the LCD when there is a present user detected in the image (step 180). In addition, the control method for the backlight module of the LCD 100 may further include the step of shutting down the camera when there has been no user detected in the image for a long time (step 190). FIG. 2 is an embodiment of step 180 and step 190 in FIG. 1. Step 180 and step 190 may include following steps:

In step 210, keep capturing an image in front of a LCD by a camera periodically when a backlight module of the LCD is turned off. In step 220, detect if there is a human face in the image to determine if there is any user in front of the LCD.

In step 230, record the time at which the image is captured when there is no human face detected in the image. In step 240, calculate the elapsed time, which there has been no human face detected in the image for, according to the recorded times. In other words, there has been no user in front of the LCD for the elapsed time calculated by step 240.

In step 250, determine if the elapsed time is longer than shutting-down time. The shutting-down time can be set through a user interface, and the shutting-down time may be set longer than the turn-off time for backlight.

When the elapsed time is shorter than the shutting-down time, keep capturing an image in front of the LCD periodically (step 210). On the other hand, when the elapsed time is longer than the shutting-down time, shut down the camera (step 260). Therefore, when no user is detected in front of the LCD for a long time, power consumption can be further saved by shutting down the camera.

In addition, when there is a human face detected in the image by detection of the step 220, turn on the backlight module of the LCD (step 280). In other words, when there is a human face of a user detected in front of the LCD, the backlight module of the LCD can be turned on to provide light to a panel of the LCD for display.

Before step 280, determine if a present user in front of the LCD is the same as a previous user (step 270). The backlight module of the LCD is turned on only when the present user in front of the LCD is the same as the previous user (step 280). Therefore, the content displayed on the LCD wouldn't be shown to others after the previous user leaves.

In addition, step 270 can be accomplished through determining if the face in the image is the same as the face in the previous image. When the backlight module of the LCD was turned on previously and there was a human face detected in the image, the image was stored as the previous image.

Furthermore, step 270 can be also accomplished through capturing the present user's facial feature from the image, and comparing the present user's facial feature with the previous user's facial feature. Wherein the present user is determined to be the same as the previous user when the present user's facial feature is the same as the previous user's facial feature. When the backlight module of the LCD was turned on previously and there was a human face detected in the image, a feature of the human face was captured from the image, and the captured feature of the human face was stored as the previous user's facial feature. In addition, several facial features of the present user can be captured from the image for comparison in other embodiments.

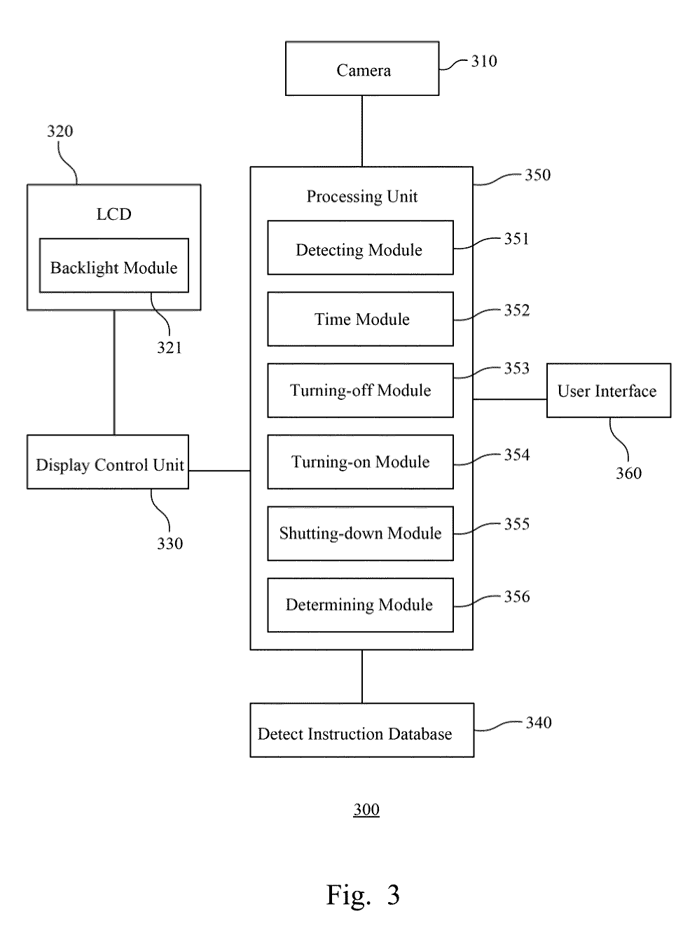

FIG. 3 is a block diagram of an electrical device according to another embodiment of this invention. The electrical device detects if there is any user in front of a LCD of the electrical device. When there has been no user in front of the LCD for a period of time, turn off a backlight module of the LCD of the electrical device. The electrical device 300 includes a camera 310, a LCD 320, a display control unit 330, a detect instruction database 340 and a processing unit 350. The camera 310 is a WEBCAM or any other camera for capturing an image in front of the LCD 320 periodically. The LCD 320 includes a backlight module 321. Light source of the backlight module 321 may be at least a cold cathode fluorescent lamp (CCFL), at least a light-emitting diode (LED), or any other light source. The display control unit 330 controls the LCD 320. The detect instruction database 340 stores at least a detect instruction. The processing unit 350 includes a detecting module 351, a time module 352 and a turning-off module 353. The detecting module 351 detects if there is a human face in the image with the detect instruction. The detection instruction utilized by the detecting module 351 may detect if there is any human facial features, such as eyebrows, nose, mouth or any other facial features, in the image to determine if there is a human face in the image. When no human face is detected in the image, the time module 352 records time at which the image is captured by the camera 310 and calculates elapsed time, which there has been no human face detected in the image for, according to the recorded times. When the elapsed time is longer than turn-off time for backlight, the turning-off module 353 turns off the backlight module 321 of the LCD 320 through the display control unit 330. Users may set value of the turn-off time for backlight through a user interface 360 of the electrical device 300.

In practice, the LCD 320 consumes much more power than other elements of the electrical device 300 does, and the backlight module 321 of the LCD 320 consumes more power than other elements of the LCD 320 does. For example, when light source of the backlight module 321 is at least a CCFL, the power consumption of the backlight module 321 is 70%˜80% of the power consumption of the LCD 320. Therefore, when there is no user in front of the LCD 320, turning off the backlight module 321 can significantly reduce the power consumption of the LCD 320.

In addition, power consumed by the camera 310, is much less than power saved by turning off the backlight module 321. Therefore, compared with other normal electrical devices, the electrical device 300 can still reduce power consumption significantly when the camera 310 continues to capture an image. Thus, when the electrical device 300 consumes power from a battery, the battery life can be extended.

The processing unit 350 may further include a turning-on module 354. When the backlight module 321 is turned off and there is a human face detected in the image, the turning-on module 354 turns on the backlight module 321 through the display control unit 330. In other words, the backlight module 321 is turned on when a present user detected in front of the LCD 320 to provide light to a panel of the LCD 320 for display.

In addition, when the backlight module 321 is turned off and there is a present user detected in front of the LCD 320, the electrical device 300 may determine if the present user detected in front of the LCD 320 is the same as a previous user. Only when the present user detected in front of the LCD 320 is the same as the previous user, the electrical device 300 turns on the backlight module 321. Therefore, the processing unit 350 of the electrical device 300 further includes a determining module 356 for determining if the present user in front of the LCD 320 is the same as the previous user. The turning-on module 354 turns on the backlight module 321 through the display control unit 330 only when the present user is the same as the previous user. Therefore, the content displayed on the LCD 320 wouldn't be shown to others after the previous user leaves the LCD 320 of the electrical device 300.

In detail, when the backlight module 321 is turned off and there is a human face detected in the image, determining module 356 may determine if the face in the image is the same as the face in a previous image to determine if the present user in front of the LCD 320 is the same as the previous user. The turning-on module 354 turns on the backlight module 321 through the display control unit 330 only when the face in the image is the same as the face in the previous image. When the backlight module 321 was turned on previously and there was a human face detected in the image, the detecting module 351 stored the image as the previous image.

Furthermore, when the backlight module 321 is turned off and a human face is detected in the image, the determining module 356 may capture a present user's facial feature from the image. Then, the determining module 356 compares the present user's facial feature with the previous user's facial feature to determine if the present user is the same as the previous user. The turning-on module 354 turns on the backlight module 321 through the display control unit 330 only when the present user is the same as the previous user. When the backlight module 321 of the LCD 320 is turned on previously and there was at least a human face detected in the image, the detecting module 351 captured a facial feature from the front image and stored the captured facial feature as the previous user's facial feature. In addition, the determining module 356 may capture several facial features of the present user from the image for comparison in other embodiments.

The processing unit 350 may further include a shutting-down module 355. When the elapsed time is longer than shutting-down time, shutting-down module 355 shuts down the camera 310. Value of the shutting-down time can be set through a user interface 360, and may be set to larger than the value of the turn-off time for backlight. Therefore, when there has been no user detected in front of the LCD 320 for a period of time, the camera 310 may be shut down for further saving power consumption.

Although the present invention has been described in considerable detail with reference to certain embodiments thereof, other embodiments are possible. Therefore, their spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A control method for a backlight module of a liquid crystal display (LCD), comprising:
initializing a camera;
capturing an image in front of the LCD by the camera periodically;
detecting if there is a human face in the image;
recording time at which the image is captured when there is no human face detected in the image;
calculating elapsed time, which there has been no human face detected in the image for, according to the recorded times; and
turning off the backlight module of the LCD when the elapsed time is longer than turn-off time for backlight.

2. The control method for the backlight module of the LCD of claim 1, further comprising:
turning on the backlight module of the LCD when the backlight module of the LCD is turned off and there is the human face detected in the image.

3. The control method for the backlight module of the LCD of claim 1, further comprising:
determining if the elapsed time is longer than shutting-down time when the backlight module of the LCD is turned off; and
shutting down the camera when the elapsed time is longer than the shutting-down time.

4. The control method for the backlight module of the LCD of claim 3, further comprising:
setting the shutting-down time.

5. The control method for the backlight module of the LCD of claim 1, further comprising:
determining if the face in the image is the same as the face in a previous image when the backlight module of the LCD is turned off and there is the human face detected in the image; and
turning on the backlight module of the LCD when the face in the image is the same as the face in the previous image.

6. The control method for the backlight module of the LCD of claim 5, further comprising:
storing the image as the previous image when the backlight module of the LCD is turned on and there is the human face detected in the image.

7. The control method for the backlight module of the LCD of claim 1, further comprising:
capturing a present user's facial feature from the image when the backlight module of the LCD is turned off and there is the human face detected in the image;
comparing the present user's facial feature with a previous user's facial feature to determine if the present user is the same as the previous user; and
turning on the backlight module of the LCD when the present user is the same as the previous user.

8. The control method for the backlight module of the LCD of claim 7, further comprising:
capturing a feature of the human face from the image and storing the captured feature of the human face as the previous user's facial feature when the backlight module of the LCD is turned on and there is the human face detected in the image.

9. The control method for the backlight module of the LCD of claim 1, further comprising:
setting the turn-off time for backlight.

10. An electrical device, comprising:
a LCD, comprising a backlight module;
a camera for capturing an image in front of the LCD periodically;
a display control unit for controlling the LCD;
a detect instruction database for storing at least a detect instruction; and
a processing unit, comprising:
a detecting module for detecting if there is a human face in the image with the detect instruction;
a time module for recording time at which the image is captured by the camera and calculating elapsed time, which there has been no human face detected in the image for, according to the recorded times when there is no human face detected in the image; and
a turning-off module for turning off the backlight module of the LCD through the display control unit when the elapsed time is longer than turn-off time for backlight.

11. The electrical device of claim 10, wherein the processing unit further comprises:
a turning-on module for turning on the backlight module of the LCD through the display control unit when the backlight module of the LCD is turned off and there is the human face detected in the image.

12. The electrical device of claim 10, wherein the processing unit further comprises:
a shutting-down module for shutting down the camera when the backlight module of the LCD is turned off.

13. The electrical device of claim 10, wherein the processing unit further comprises:
a determining module for determining if a face detected in the image is the same as a face in a previous image when there is the human face detected in the image; and
a turning-on module for turning on the backlight module of the LCD through the display control unit when the backlight module of the LCD is turned off and the face detected in the image is the same as the face in the previous image.

14. The electrical device of claim 10, wherein the processing unit further comprises:
a determining module for capturing a present user's facial feature from the image and determining if the present user is the same as a previous user by comparing the user's facial feature with the previous user's facial feature when the backlight module of the LCD is turned off and there is the human face detected in the image; and
a turning-on module for turning on the backlight module of the LCD through the display control unit when the present user is the same as the previous user.
